(19) United States
(12) Patent Application Publication
(10) Pub. No.: US 2014/0140817 A1
(43) Pub. Date: May 22, 2014

(54) MICRO GAS TURBINE HAVING COMPACT STRUCTURE

(71) Applicant: STX HEAVY INDUSTRIES, CO., LTD., Gyeongsangnam-do (KR)

(72) Inventors: Jong Hoon KIM, Chungcheongbuk-Do (KR); Byung Hwa KIM, Daegu (KR); Chang Ho KIM, Seoul (KR); Kyu Ho SIM, Seoul (KR); Tae Ho Kim, Seoul (KR)

(73) Assignee: STX HEAVY INDUSTRIES, CO., LTD., Gyeongsangnam-do (KR)

(21) Appl. No.: 14/072,238

(22) Filed: Nov. 5, 2013

(30) Foreign Application Priority Data
Nov. 22, 2012 (KR) 10-2012-0133030

(51) Int. Cl. F02C 7/06

(52) U.S. Cl. CPC F02C 7/06
USPC 415/122.1

(57) ABSTRACT

Disclosed is a micro gas turbine having a compact structure. The micro gas turbine includes a turbine wheel, a tie shaft connected, at one end thereof, to the turbine wheel, a compressor wheel spaced from the turbine wheel and mounted to the tie shaft, a thrust rotor spaced from the compressor wheel and fixed to an end of the tie shaft, a thrust collar provided on a portion of an outer surface of the thrust rotor, and a sub journal bearing provided between the thrust collar and the compressor wheel.

### BACKGROUND OF THE INVENTION

1. Field of the Invention

The present invention relates, in general, to a micro gas turbine having a compact structure. More particularly, the present invention relates to a micro gas turbine having a compact structure in which a sub journal bearing is disposed between a thrust collar and a compressor wheel, i.e. adjacent to a thrust bearing on the side of a compressor, so as to reduce the whole length and weight of a rotor and thus obtain the compact structure, and in which a pair of main journal bearings, which are spaced by a certain distance, are disposed between a hallow shaft and a sleeve so as to sufficiently support a shaft between the compressor and a turbine, in which a great amount of dynamic pressure is generated due to revolution, thereby maximizing the stability of the micro gas turbine.

2. Description of the Related Art

On the side of countries that use a great amount of energy depending on energy imports, efficient production and use of energy are important factors to improve the national competitiveness. One of the solutions may become development and propagation of a decentralized micro gas turbine cogeneration system in which cogeneration plants are installed at a variety of distributed demanded bases in order to simultaneously produce and stably supply electricity and useful heat. The power system using the micro gas turbine may be a newly developed stable power system which can reduce the cost for building large scaled power plants and loss of power transmission/heat transport.

FIG. 1 is a schematic constructional view of a conventional micro gas turbine having a generator, a compressor, and a turbine.

Referring to FIG. 1, the conventional micro gas turbine has a structure in which the generator 12 is connected with the compressor 14 and the turbine 15 via a shaft. The generator 12 and the compressor 14/the turbine 15 are connected by means of a coupling 16. Here, a section on the right of the coupling 16 in FIG. 1, where the compressor 14 and the turbine 15 are disposed, is generally called a core engine.

The core engine is provided with a main journal bearing 44 and a sub journal bearing 48, which support revolution, and a thrust bearing 40 which support the shaft.

As shown in FIG. 1, the sub journal bearing 48 is disposed between the coupling 16 and the thrust bearing 40, i.e. at a left side of the core engine, so as to support the revolution of a rotary shaft, thereby preventing the vertical movement (in FIG. 1) of the rotary shaft and reducing friction force applied to the rotary shaft.

However, in the case where the sub journal bearing 48 is disposed at the left side of the core engine as such, as shown in FIG. 1, the whole length and weight of the core engine increase. More specifically, the length of the core engine increases by the length of the sub journal bearing 48, and the length of a rotor, which is inserted into the sub journal bearing 48, also increases by the length of the sub journal bearing 48, thereby increasing the weight of the entire core engine. Such an increase in length and weight of the core engine causes the whole size and thus an occupied space of the micro gas turbine to increase, thereby reducing the operation efficiency of the micro gas turbine.

The main journal bearing 44 is disposed between the compressor 14 and the turbine 15. Generally, the main journal bearing 44 consists of a single bearing so as to support the revolution driven by the compressor 14 and the turbine 15.

However, the compressor 14 and the turbine 15 are sections where dynamic pressure is generated in the micro gas turbine due to revolution operation thereof, so that it is difficult for one main journal bearing 44 to sufficiently support the dynamic pressure generated due to the revolution operation.

### SUMMARY OF THE INVENTION

Accordingly, the present invention has been made keeping in mind the above problems occurring in the related art, and the present invention is intended to propose a micro gas turbine having a compact structure in which the whole length and weight of a rotor is reduced, thereby providing the compact structure, and which sufficiently supports a shaft between a compressor and a turbine, to which a great amount of dynamic pressure is generated due to the revolution operation, thereby maximizing the stability of the micro gas turbine.

In order to achieve the above object, according to one aspect of the present invention, there is provided a micro gas turbine having a compact structure, the micro gas turbine including: a turbine wheel; a tie shaft connected, at one end thereof, to the turbine wheel; a compressor wheel spaced from the turbine wheel and mounted to the tie shaft; a thrust rotor spaced from the compressor wheel and fixed to an end of the tie shaft; a thrust collar provided on a portion of an outer surface of the thrust rotor; and a sub journal bearing provided between the thrust collar and the compressor wheel.

The thrust collar may be respectively provided on both sides thereof with a generator-side thrust bearing and a compressor-side thrust bearing, and the sub journal bearing may be disposed adjacent to the compressor-side thrust bearing so as to surround the thrust rotor.

The micro gas turbine may further include a hallow shaft disposed between the compressor wheel and the turbine wheel, a sleeve surrounding a portion of an outer surface of the hallow shaft, and first and second main journal bearings spaced from each other and disposed between the hallow shaft and the sleeve.

According to the present invention, the sub journal bearing is disposed between the thrust collar and the compressor wheel, i.e. adjacent to the compressor-side thrust bearing, thereby reducing the whole length and weight of a rotor and thus accomplishing a compact structure.

Further, according to the present invention, a pair of spaced main journal bearings is provided between the hallow shaft and the sleeve, thereby sufficiently supporting the shaft between the compressor and the turbine, to which dynamic pressure is greatly generated due to a revolution operation, and thus maximizing the operation stability of the micro gas turbine.

### BRIEF DESCRIPTION OF THE DRAWINGS

The above and other objects, features and advantages of the present invention will be more clearly understood from the following detailed description when taken in conjunction with the accompanying drawing, in which:

FIG. 1 is a schematic constructional view of a conventional micro gas turbine including a generator, a compressor, and a turbine;

FIG. 2 is a schematic constructional view of a micro gas turbine having a compact structure according to an embodiment of the present invention;

FIG. 3 is a detailed sectional view of a sub journal bearing shown in FIG. 2; and

FIG. 4 is a partially enlarged sectional view of a micro gas turbine having a compact structure according to another embodiment of the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts. In the following description, it is to be noted that, when the functions of conventional elements and the detailed description of elements related with the present invention may make the gist of the present invention unclear, a detailed description of those elements will be omitted. Further, it should be understood that the embodiment of the present invention may be changed to a variety of embodiments by a person skilled in the art and the scope and spirit of the present invention are not limited to the embodiment described hereinbelow.

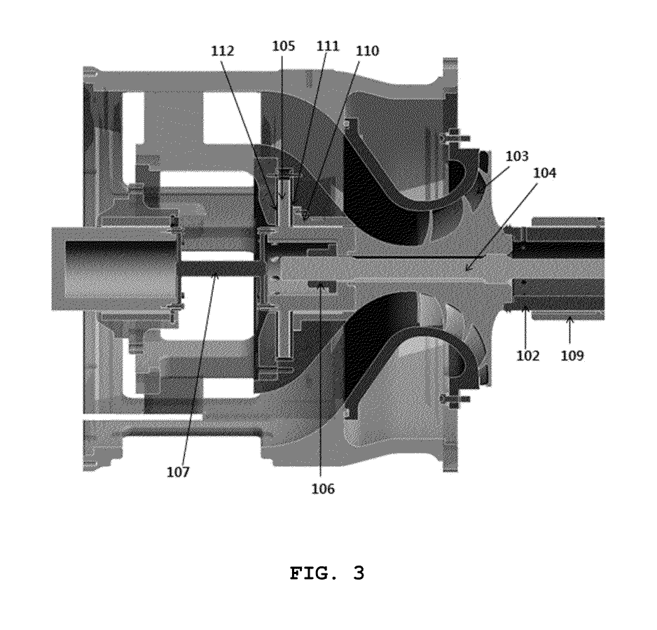

FIG. 2 is a schematic constructional view of a micro gas turbine having a compact structure according to an embodiment of the present invention, and FIG. 3 is a detailed sectional view of a sub journal bearing shown in FIG. 2.

Referring to FIGS. 2 and 3, the micro gas turbine having a compact structure according to an embodiment of the present invention includes a turbine wheel 101, a hallow shaft 102, a compressor wheel 103, a tie shaft 104, a thrust collar 105, a tie nut 106, a coupling 107, a generator shaft 108, a main journal bearing assembly 109, a sub journal bearing 110, a compressor-side thrust bearing 111, a generator-side thrust bearing 112, generator bearings 113 and 114, and a thrust rotor 150. Here, in FIG. 2, the right part relative to the coupling 107 is called a core engine 115.

The compressor wheel 103 is spaced from the turbine wheel 101 and is mounted to the tie shaft 104.

The thrust motor 150 is spaced from the compressor wheel 103 and is fixed to an end of the tie shaft 104.

The thrust collar 105 is provided on a portion of an outer surface of the thrust rotor 150.

The thrust collar 105 is respectively provided on both sides thereof with a generator-side thrust bearing 112 and a compressor-side thrust bearing 111. The thrust bearings 111 and 112 support the left and right movement (in FIG. 2) of a shaft.

One end of the tie shaft 104 is connected to the turbine wheel 101 and the other end of the tie shaft is contained in the thrust rotor 150.

The tie nut 106 integrates the turbine wheel 101, the hallow shaft 102, the compressor wheel 103, the tie shaft 104, and the thrust collar 105 into a single unit as a rotor.

Revolutions of the turbine wheel 101 and the compressor wheel 103 are supported by the hallow shaft 102 and the main journal bearing assembly 109.

The coupling 107 connects the generator shaft 108 and the core engine 115, and transmits a rotating force generated from the core engine 115 to the generator shaft 108.

The generator bearings 113 and 114 support the rotation of the generator shaft 108.

The sub journal bearing 110 is disposed between the thrust collar 105 and the compressor wheel 103. Specifically, the sub journal bearing 110 is disposed adjacent to the compressor-side thrust bearing 111 so as to surround the thrust rotor 150.

Referring to FIG. 3, one end (left side in FIG. 3) of the sub journal bearing 110 is bent into a generally right-angled frame in sectional shape, and is fixed by means of a fastening member or the like. One end of the sub journal bearing 110 is disposed adjacent to the compressor-side thrust bearing 111.

The other end (right side in FIG. 3) of the sub journal bearing 110 is formed into a shape that corresponds to s shape of an inner wall of an oil path formed in the direction of the compressor wheel 103 such that the other end does not interfere with the oil path, thereby allowing the inner wall of the oil path to be maintained to be smooth. For example, the other end of the sub journal bearing 110 may be aligned to match with the end of the thrust rotor 150.

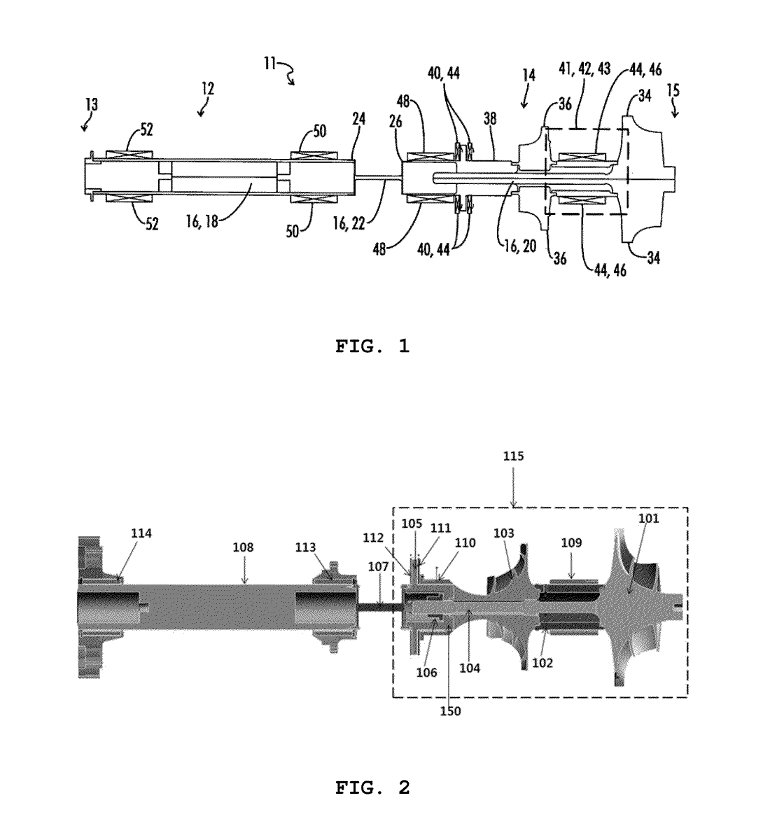

Since the sub journal bearing 110 is disposed between the thrust collar 105 and the compressor wheel 103, i.e. adjacent to the compressor-side thrust bearing 111, the whole length and weight of the rotor is reduced, thereby obtaining a compact structure. In contrast to the conventional structure shown in FIG. 1 in which the sub journal bearing 48 is disposed between the coupling 16 and the thrust bearing 40, i.e. at the left side of the core engine, the present configuration shown in FIGS. 2 and 3 in which the sub journal bearing 110 is disposed adjacent to the compressor wheel 103 enables the length of the left side of the core engine to decrease by the length of the sub journal bearing. Further, the length of the rotor inserted into the sub journal bearing decreases by the length of the sub journal bearing, thereby reducing the weight of the entire core engine.

Such a reduction in length and weight of the core engine 115 also reduces the size and occupied space of the entire micro gas turbine and thus increases the operation efficiency thereof.

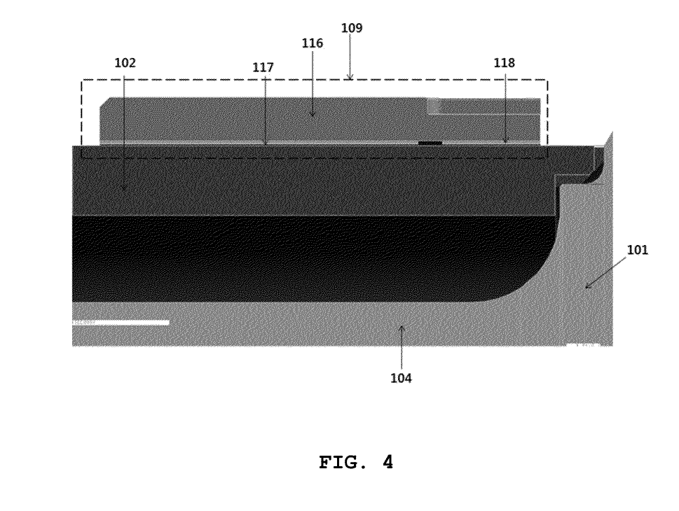

FIG. 4 is a partially enlarged sectional view of a micro gas turbine having a compact structure according to another embodiment of the present invention. The embodiment of FIG. 4 is similar to those of FIGS. 2 and 3, excluding that a main journal bearing consists of a pair of main journal bearings, so a description thereof will be made of such a difference.

Referring to FIG. 4, the micro gas turbine of this embodiment includes a turbine wheel 101, a hallow shaft 102, a tie shaft 104, and a main journal bearing assembly 109.

The hallow shaft 102 is disposed between the turbine wheel 101 and a compressor wheel 103.

The main journal bearing assembly 109 includes a sleeve 116, and first and second main journal bearings 117 and 118.

The sleeve 116 is formed into a shape to surround a portion of an outer surface of the hallow shaft 102. The hallow shaft 102 and the main journal bearing assembly 109 support the rotation of the turbine wheel 101 and the compressor wheel 103.

The first and second main journal bearings 117 and 118 are spaced a distance from each other and are disposed between the hallow shaft 102 and the sleeve 116.

As described in the description of the related art, the conventional main journal bearing 44 shown in FIG. 1 consists of a single main journal bearing, so as to support the rotation driven by the compressor 14 and the turbine 15. In contrast, according to the present invention, the main journal bearings 117 and 118 are provided in a pair in a spaced manner, so that the main journal bearings can sufficiently support the shaft between the compressor and the turbine, to which dynamic pressure is greatly generated due to the rotation thereof, thereby maximizing the operation stability of the micro gas turbine.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, it should be understood that the disclosed embodiments and illustrated drawings are merely illustrative forms in all aspects, rather than limited ones and the technical scope of the invention is not limited to the embodiments and drawings. The claimed scope of the invention should be interpreted by the following claims, and all of the technical ideas equivalent thereto should be construed as being covered by the claimed scope of the invention.

What is claimed is:

1. A micro gas turbine having a compact structure, the micro gas turbine comprising:
a turbine wheel;
a tie shaft connected, at one end thereof, to the turbine wheel;
a compressor wheel spaced from the turbine wheel and mounted to the tie shaft;
a thrust rotor spaced from the compressor wheel and fixed to an end of the tie shaft;
a thrust collar provided on a portion of an outer surface of the thrust rotor; and
a sub journal bearing provided between the thrust collar and the compressor wheel.

2. The micro gas turbine according to claim 1, wherein the thrust collar is respectively provided on both sides thereof with a generator-side thrust bearing and a compressor-side thrust bearing, and the sub journal bearing is disposed adjacent to the compressor-side thrust bearing so as to surround the thrust rotor.

3. The micro gas turbine according to claim 1, further comprising: a hallow shaft disposed between the compressor wheel and the turbine wheel; a sleeve surrounding a portion of an outer surface of the hallow shaft; and first and second main journal bearings spaced from each other and disposed between the hallow shaft and the sleeve.
